(19) United States
(12) Patent Application Publication
(10) Pub. No.: US 2001/0028421 A1
(43) Pub. Date: Oct. 11, 2001

(54) Liquid crystal display device and driving method therefor

(76) Inventors: Naoki Masazumi, Kobe-Shi (JP); Katsuyuki Nanba, Sakai-Shi (JP)

Correspondence Address: SIDLEY AUSTIN BROWN & WOOD, 717 NORTH HARWOOD, SUITE 3400, DALLAS, TX, 75201, US

(21) Appl. No.: 09/817,546

(22) Filed: Mar. 26, 2001

(30) Foreign Application Priority Data
Mar. 31, 2000 (JP) 2000-097534

(51) Int. Cl. G02F 1/1347

(52) U.S. Cl. 349/74

(57) ABSTRACT

Disclosed herein is a liquid crystal display device that essentially comprises a liquid crystal display unit and an electric circuit unit. The liquid crystal display unit comprises three liquid crystal panels, i.e., blue, green and red liquid crystal panels respectively containing blue, green and red liquid crystal layers and scanning electrodes, while the electric circuit unit comprises blue and green scanning electrode drive circuit that is connected to the scanning electrodes of the blue and green liquid crystal panels, and a red scanning electrode drive circuit that is connected to the scanning electrodes of the red liquid crystal panel. Since the blue and green scanning electrode drive circuit is provided common to the blue and green liquid crystal panels, and since the blue and green liquid crystal layers has substantially same electrical characteristic, the structure of the device can be simplified without decreasing image quality.

### CROSS-REFERENCE TO RELATE APPLICATION

This application is based on Japanese Patent Application No. 2000-097534 filed in Japan on Mar. 31, 2000, the entire content of which is hereby incorporated by reference.

### BACKGROUND OF THE INVENTION

1. Field of the Invention

The present invention relates to a liquid crystal display device comprising at least three liquid crystal panels glued together, as well as to a driving method therefor, and more particularly, to a liquid crystal display device comprising three dot matrix liquid crystal panels stacked together, each of which reflects one of the three primary colors, i.e., blue, green and red, respectively, as well as to a driving method therefor.

2. Description of the Related Art

A conventional liquid crystal display device and a driving method therefor will be explained with reference to FIGS. 5 through 7. FIG. 5 is a block diagram showing the construction and driving method for the conventional liquid crystal display device 51. As shown in FIG. 5, the conventional liquid crystal display device 51 essentially has a liquid crystal display unit 52 and an electric circuit unit 53. FIG. 6 is a plan view of the conventional liquid crystal display unit 52, and FIG. 7 is a cross-sectional view of the liquid crystal display unit 52 seen from the VII-VII line in FIG. 6.

This liquid crystal display unit 52 will first be explained. With reference to FIG. 5, this liquid crystal display unit 52 essentially comprises a blue liquid crystal panel 60, a green liquid crystal panel 70 and a red liquid crystal panel 80 sequentially stacked together in this order from the top when seen by an observer. As shown in FIG. 6, the liquid crystal panels 60, 70 and 80 are glued together such that they completely overlap with each other (i.e., are perfectly aligned), such that they appear to comprise a single liquid crystal panel in a plan view. As shown in FIG. 7, the liquid crystal panels 60, 70 and 80 are glued together using an adhesion film 55 located between each panel, and a light absorbing film 56 is formed under the bottommost red liquid crystal panel 80.

The blue liquid crystal panel 60 has a pair of opposing substrates 62a and 62b, and a blue liquid crystal layer 66 that selectively reflects blue light therebetween. Similarly, the green liquid crystal panel 70 and red liquid crystal panel 80 respectively have a pair of opposing substrates 72a and 72b and a green liquid crystal layer 76 that selectively reflects green light therebetween, and a pair of opposing substrates 82a and 82b and a red liquid crystal layer 86 that selectively reflects red light therebetween. In addition, the blue liquid crystal panel 60 has scanning electrodes 64a that extend parallel to each other and are located on one of the opposing substrates, i.e., the substrate 62a, and data electrodes 64b that extend perpendicular to the scanning electrodes 64a and are located on the other substrate 62b. Similarly, the green liquid crystal panel 70 and red liquid crystal panel 80 respectively have on the opposing substrates 72 and 82 scanning electrodes 74a and 84a and data electrodes 74b and 84b that extend perpendicular to the scanning electrodes. When the liquid crystal layer between scanning electrode 64a, 74a or 84a and a data electrode 64b, 74b or 84b to which a prescribed voltage is applied reflects light, a prescribed pixel is formed. The user can visually recognize an image comprising prescribed pixels of the three primary colors when observing the liquid crystal display unit 52 from above in FIG. 7. This image is formed through the additive color mixture of the blue light, green light and red light of the CIE color system.

The electric circuit unit 53 will now be explained. The electric circuit unit 53 has a CPU 90 that interfaces image signals from an external circuit and a controller 91 that allocates post-processing image signals to the data drivers and scanning drivers described below. The electric circuit unit 53 also has data drivers 92, 93 and 94 (B-column, G-column, R-column) and scanning drivers 95, 96 and 97 (B-row, G-row, R-row) that respectively form data writing signals and scanning signals for the blue liquid crystal panel 60, green liquid crystal panel 70 and red liquid crystal panel 80 based on the image signals provided from the controller 91.

The blue scanning driver 95 is connected to the scanning electrodes 64a of the blue liquid crystal panel 60, and the blue data driver 92 is connected to the data electrodes 64b thereof Similarly, the green scanning driver 96 and red scanning driver 97, as well as the green data driver 93 and red data driver 94, are respectively connected to the green liquid crystal panel 70 and red liquid crystal panel 80.

The data drivers 92, 93 and 94 and scanning drivers 95, 96 and 97 each generate data writing signals and scanning signals to drive the liquid crystal panel 60, 70 and 80, respectively, when image signals are provided from an external circuit through the CPU 90 and controller 91. The liquid crystal panels 60, 70 and 80 individually receive the data writing signals and scanning signals, and respectively display blue, green and red images, whereupon a color image is formed when the liquid crystal display unit 52 is seen as a whole.

Incidentally, as shown in FIG. 7, for example, when the liquid crystal display unit 52, which comprises blue, green and red liquid crystal panels 60, 70 and 80 stacked in this order, is viewed from above, if white incident light is reflected by the blue liquid crystal panel 60, a blue image is obtained, but in order to obtain a red image, the incident light must pass through the blue and green liquid crystal panels 60 and 70, be reflected by the red liquid crystal panel 80, and pass through the blue and green liquid crystal panels 60 and 70 once more. When this happens, the intensity of the red reflected light by which a red image is obtained attenuates when it passes through the blue and green liquid crystal panels 60 and 70, and therefore, the red image becomes darker than the blue reflected light by which a blue image is obtained. Therefore, with such a liquid crystal display device 51, because differences in light intensity exist among the blue reflected light, green reflected light and red reflected light due to the order of stacking, a bluish image having a poor quality for observation is formed when the liquid crystal display unit 52 is viewed as a whole. In other words, in order to form an image having superior quality for observation, the intensity of reflected light from the blue, green and red liquid crystal panels 60, 70 and 80, which are stacked, must be adjusted such that they all have an equivalent level of light intensity.

Generally, a method is used to increase the intensity of reflected light from a liquid crystal layer wherein the thickness of the liquid crystal layer is increased such that the drive voltage level, and consequently the reflectance of the liquid crystal layer, increases. In other words, in the conventional liquid crystal display device 51 and driving method therefor, in order to realize a liquid crystal display device 51 having good quality for observation, a method to change the reflectance of each liquid crystal layer 66, 76 and 86 was generally used in order to compensate for the differences in the intensity of reflected light.

In addition, research is underway in which the level of drive voltage supplied to the liquid crystal panels 60, 70 and 80 is kept the same, i.e., the liquid crystal panels 60, 70 and 80 are driven using one drive circuit, and ease of observation is realized through the selection of an appropriate thickness and liquid crystal material for each liquid crystal layer. However, while it is possible to achieve balance in the intensity of the blue and green reflected light through selection of the appropriate thickness and liquid crystal material for each liquid crystal layer while the identical drive voltage is applied to each of the three layers, the method still entails the issue of how to make the red reflected light as bright as the blue reflected light.

The display state (ease of observation) also changes depending on the temperature characteristic of the liquid crystal layer as the ambient temperature changes. Consequently, if one liquid crystal layer has a temperature characteristic different from the other liquid crystal layers, the problem arises that, if all of the liquid crystal layers are driven using one drive circuit, optimal temperature compensation cannot be performed.

As described above, where the liquid crystal panels 60, 70 and 80 are driven at different drive voltage levels in order to realize a liquid crystal display device 51 offering good ease of observation, three scanning drivers 95, 96 and 97 are thought to be essential. However, in order to reduce the cost to the extent possible, the number of scanning drivers should be reduced as much as possible. Increasing the number of scanning drivers used by a device has the effect of increasing the number of other wiring circuits required (such as flexible substrates that are not shown in the drawings, but connect the scanning drivers 95, 96 and 97 to the liquid crystal panels 60, 70 and 80, for example). Therefore, it is also necessary to reduce the number of scanning drivers in order to achieve reduced cost through the simplification of the writing circuits.

### SUMMARY OF THE INVENTION

An object of the present invention is therefore to provide a liquid crystal display device in which the number of scanning drivers is reduced without compromising the ease of observation as a liquid crystal display device. Another object of the present invention is to provide a driving method to drive multiple liquid crystal panels using one scanning driver.

In order to attain at least one of the above objects, a liquid crystal display device according to one aspect of the present invention includes: a first liquid crystal display unit comprising at least two liquid crystal layers; a second liquid crystal display unit stacked on the first liquid crystal display unit and comprising at least one liquid crystal layer; a first drive circuit that is used for the at least two liquid crystal layers of the first liquid crystal display unit and drives the first liquid crystal display unit; and a second drive circuit that drives the second liquid crystal display unit. As a result, liquid crystal layers comprising a total of at least three layers may be driven by the first and second drive circuits.

It is preferred that the first liquid crystal display unit has a blue liquid crystal layer that selectively reflects blue light and a green liquid crystal layer that selectively reflects green light, and that the second liquid crystal display unit has a red liquid crystal layer that selectively reflects red light.

Each liquid crystal layer of the first and second liquid crystal display units may include multiple scanning electrodes and signal electrodes. The first and second drive circuits may each comprise a scanning electrode drive circuit that is connected to the scanning electrodes of each liquid crystal display unit.

It is preferred that the first liquid crystal display unit comprises liquid crystal layers that have essentially the same temperature characteristic.

A liquid crystal display device according to another aspect of the present invention includes: a first liquid crystal panel comprising a first liquid crystal layer and a plurality of first scanning electrodes that are located so as to work with the first liquid crystal layer; a second liquid crystal panel comprising a second liquid crystal layer and a plurality of second scanning electrodes that are located so as to work with the second liquid crystal layer; a third liquid crystal panel comprising a third liquid crystal layer and a plurality of third scanning electrodes that are located so as to work with the third liquid crystal layer; a first scanning electrode drive circuit, provided common to the first and second liquid crystal layers, connected to the first scanning electrodes and the second scanning electrodes; and a second scanning electrode drive circuit connected to the third scanning electrodes.

This liquid crystal display device may further include a plurality of first signal electrodes that are located such that they work with the first liquid crystal layer, a plurality of second signal electrodes that are located such that they work with the second liquid crystal layer, a plurality of third signal electrodes that are located such that they work with the third liquid crystal layer, a first signal electrode drive circuit that is connected to the first signal electrodes, a second signal electrode drive circuit that is connected to the second signal electrodes, and a third signal electrode drive circuit that is connected to the third signal electrodes.

It is preferred that (i) the first liquid crystal layer be a layer that selectively reflects blue light, (ii) the second liquid crystal layer be a layer that selectively reflects green light, and (iii) the third liquid crystal layer be a layer that selectively reflects red light.

It is preferred that the temperature characteristic of the first liquid crystal layer and that of the second liquid crystal layer be substantially identical.

### BRIEF DESCRIPTION OF THE DRAWINGS

These and other objects, advantages and features of the invention will become apparent from the following description thereof taken in conjunction with the accompanying drawings in which:

FIG. 1 is a block diagram showing the construction of the liquid crystal display device pertaining to the present invention and the driving method therefor;

FIG. 2 is a plan view of the liquid crystal display unit pertaining to the present invention;

FIG. 3 is a cross-sectional view of the liquid crystal display unit seen from the III-III line in FIG. 2;

FIG. 4 is a graph showing the relationships between the drive voltages for the blue liquid crystal layer, green liquid crystal layer and red liquid crystal layer and the standardized reflectance;

FIG. 5 is a block diagram showing the construction of a conventional liquid crystal display device and the driving method therefor;

FIG. 6 is a plan view of a conventional liquid crystal display unit; and

FIG. 7 is a cross-sectional view of the liquid crystal display unit seen from the VII-VII line in FIG. 6.

### DETAILED DESCRIPTION OF THE PREFERRED EMBODIMENTS

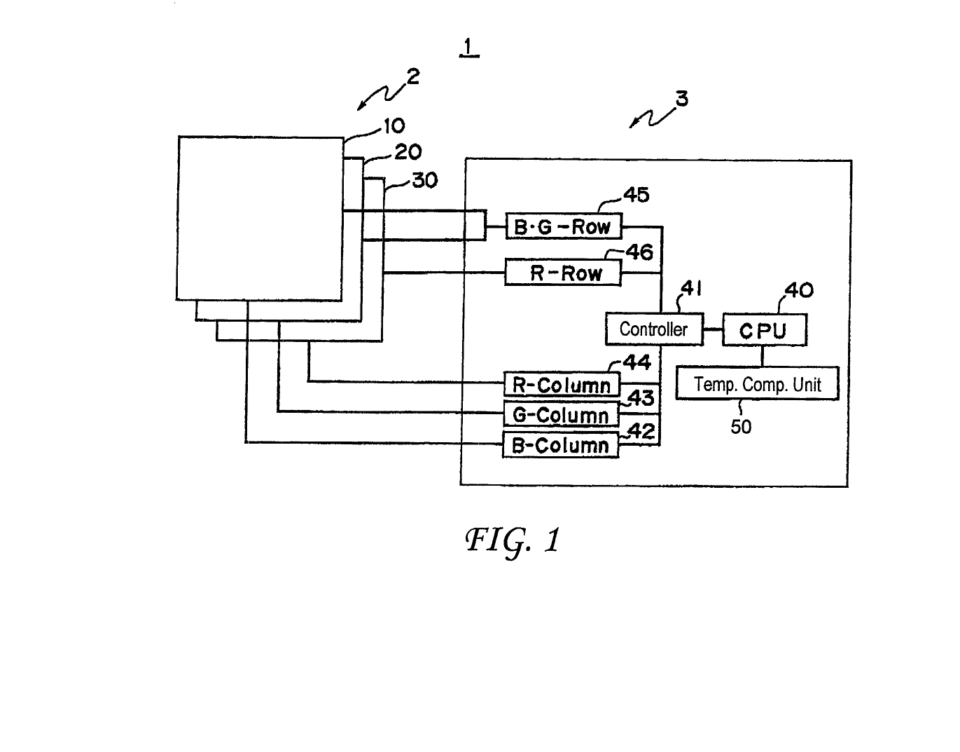

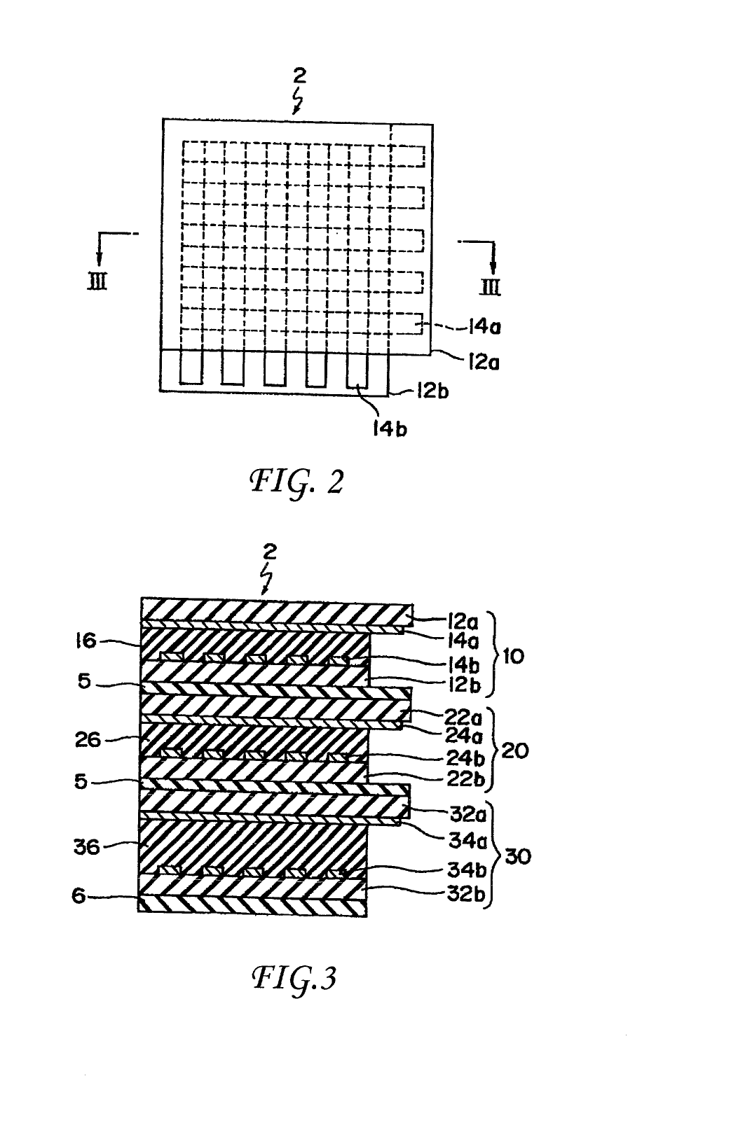

The liquid crystal display device 1 pertaining to the present invention and the driving method therefor will be explained with reference to FIGS. 1 through 4. FIG. 1 is a block diagram showing the liquid crystal display device 1 pertaining to the present invention and the driving method therefor. As shown in FIG. 1, the liquid crystal display device 1 essentially comprises a liquid crystal display unit 2 and an electric circuit unit 3. FIG. 2 is a plan view of the liquid crystal display unit 2 of the present invention, and FIG. 3 is a cross-sectional view of the liquid crystal display unit 2 seen from the III-III line in FIG. 2. In order to facilitate understanding, a dot matrix-type liquid crystal display unit 2 having five rows and five columns of pixel electrodes (scanning electrodes and data electrodes) will be used in the explanation with reference to the drawings, but the present invention is not limited by the number of pixel electrodes. In addition, terms that express a direction (such as ‘up’, ‘down’, ‘right’ and ‘left’, for example) are used from time to time in the description of the preferred embodiments, but they are used for the sake of explanation and do not limit the present invention in any respect.

The liquid crystal display unit 2 will first be explained. The liquid crystal display unit 2 in this embodiment uses so-called memory type liquid crystal (such as chiral nematic liquid crystal), for example, that can maintain the display without the application of power. With reference to FIG. 1, this liquid crystal display unit 2 essentially comprises a blue liquid crystal panel 10, a green liquid crystal panel 20 and a red liquid crystal panel 30, which are stacked together in this order from the top. While the present invention is not limited by the order of stacking of the layers, the above order is preferred. As shown in FIG. 2, the liquid crystal panels 10, 20 and 30 are glued together such that they completely overlap with each other (i.e., are perfectly aligned), such that they appear to comprise a single liquid crystal panel in a plan view. As shown in FIG. 3, the liquid crystal panels 10, 20 and 30 are glued together using an adhesion film 5 located between each panel, and a light absorbing film 6 is formed under the bottommost red liquid crystal panel 30.

The blue liquid crystal panel 10 has a pair of opposing substrates 12a and 12b, and a blue liquid crystal layer 16 that selectively reflects blue light therebetween. Similarly, the green liquid crystal panel 20 and red liquid crystal panel 30 respectively have a pair of opposing substrates 22a and 22b and a green liquid crystal layer 26 that selectively reflects green light therebetween and a pair of opposing substrates 32a and 32b and a red liquid crystal layer 36 that selectively reflects red light therebetween. In addition, the blue liquid crystal panel 10 has scanning electrodes 14a that extend parallel to each other and are located on one of the opposing substrates, i.e., the substrate 12a, and data electrodes 14b that extend perpendicular to the scanning electrodes 14a and are located on the other substrate 12b. Similarly, the green liquid crystal panel 20 and red liquid crystal panel 30 respectively have on the opposing substrates 22 and 32 scanning electrodes 24a and 34a and data electrodes 24b and 34b that extend perpendicular to the scanning electrodes. The overlapped intersections of the scanning electrode 14a and data electrode 14b of the liquid crystal layer 16, the scanning electrode 24a and data electrode 24b of the liquid crystal layer 26, and the scanning electrode 34a and the data electrode 34b of the liquid crystal layer 36 form a pixel that is a unit of display. The user can visually recognize a color image comprising prescribed pixels of the three primary colors when observing the liquid crystal display unit 2 from above in FIG. 3. This image is formed through the additive color mixture of the blue light, green light and red light of the CIE color system.

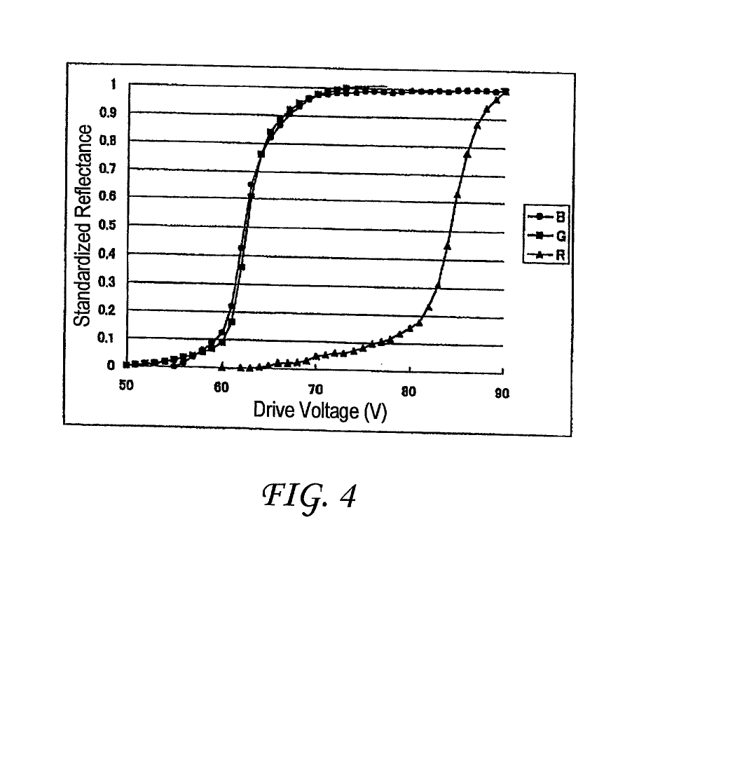

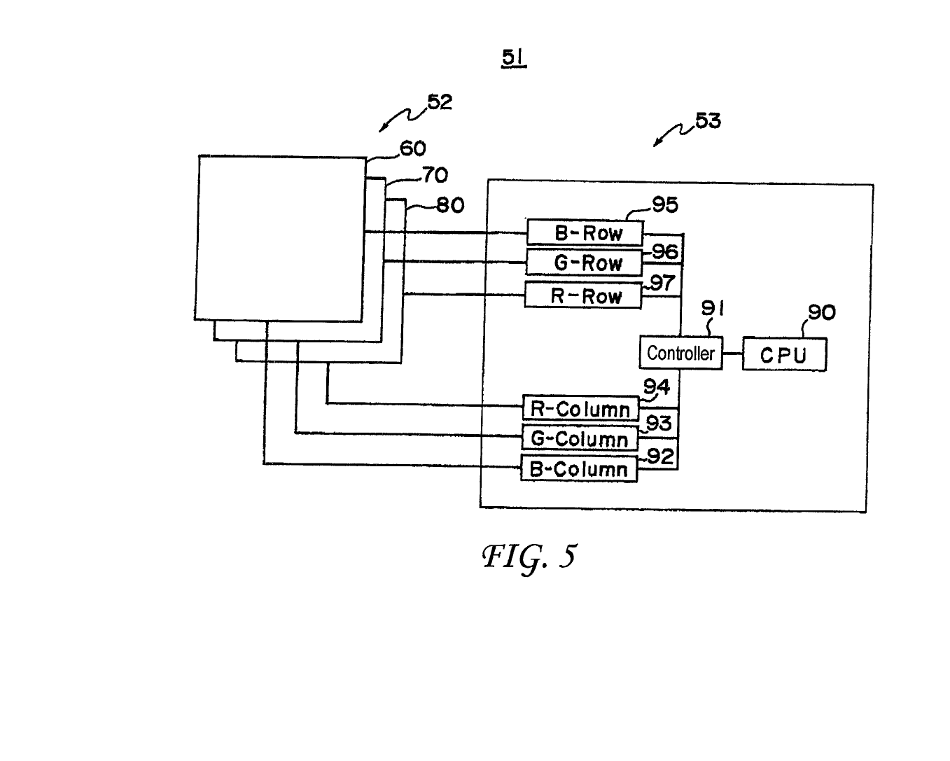

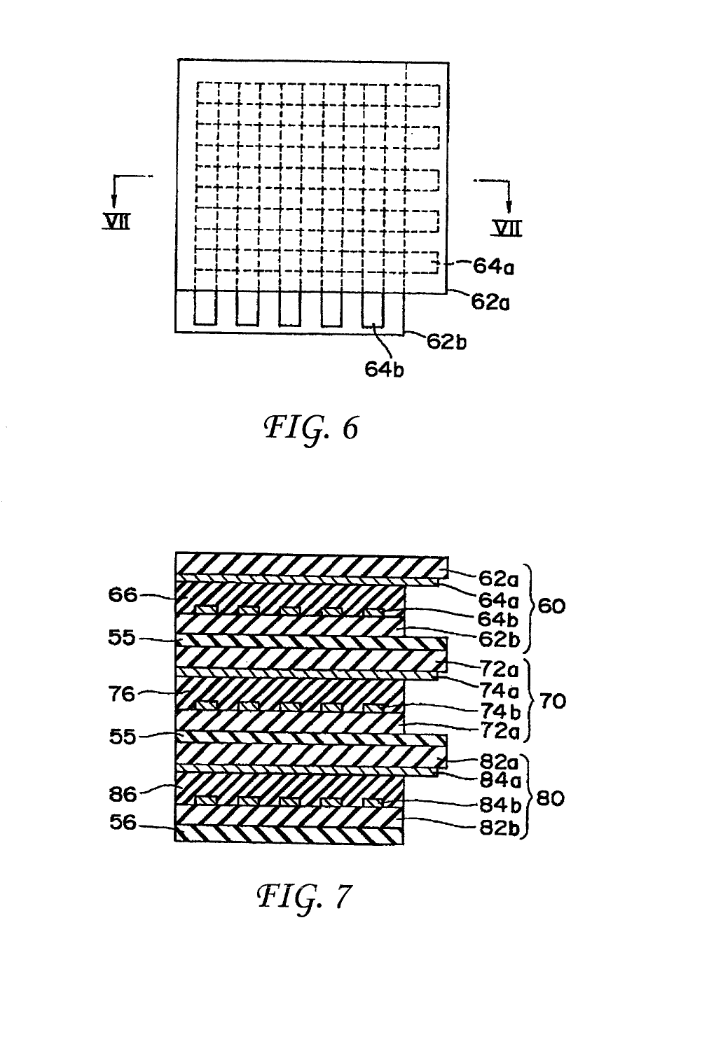

The blue liquid crystal panel 10, green liquid crystal panel 20 and red liquid crystal panel 30 are formed such that the blue liquid crystal layer 16, green liquid crystal layer 26 and red liquid crystal layer 36 have thicknesses of approximately 5 μm, 5 μm and 9 μm, respectively, and their drive voltage and the standardized reflectance have the electrooptical relationship shown in FIG. 4. While the blue liquid crystal layer 16 and green liquid crystal layer 26 have a similar electrooptical characteristic wherein their reflectance is maximized when the drive voltage is appropriately 70V, the red liquid crystal layer 36 has an electrooptical characteristic different from the other liquid crystal layers, such that its reflectance is maximized when the drive voltage is appropriately 90V. In other words, the liquid crystal layers are specified such that the blue liquid crystal layer 16 and green liquid crystal layer 26 have substantially the same thickness and electrooptical characteristic, while the red liquid crystal layer 36 has a larger thickness and higher drive voltage than the other liquid crystal layers. By increasing the reflectance of the red liquid crystal layer 36 relative to the other liquid crystal layers in this way the intensity of the red reflected light is adjusted such that it matches the intensity of the blue reflected light.

In order to make the intensity of the green reflected light match the intensity of the blue reflected light, an appropriate liquid crystal material should be selected for the green and blue liquid crystal layers, such that, for example, the reflectance of the green liquid crystal layer 26 will be larger than that of the blue liquid crystal layer 16 when the same voltage level is applied. The intensity of the reflected light from the liquid crystal layers 16, 26 and 36 may be made substantially uniform in this way, so that the ease of observation of the liquid crystal display unit 2 as a whole increases.

The electric circuit unit 3 will now be explained. The electric circuit unit 3 has a CPU 40 to interface the image signals from an external circuit and a controller 41 to allocate the post-processing image signals to the data drivers and scanning drivers described below. The electric circuit unit 3 further has data drivers 42, 43 and 44 (B-column, G-column, R-column) that form data writing signals for the blue liquid crystal panel 10, green liquid crystal panel 20 and red liquid crystal panel 30, respectively, based on the image signals provided by the controller 41, a blue and green scanning driver 45 (B/G-row) that forms scanning signals common to the blue liquid crystal panel 10 and green liquid crystal panel 20, and a red scanning driver 46 (R-row) that forms scanning signals for the red liquid crystal panel 30. The electric circuit unit 3 also includes a temperature compensating unit 50 that detects the ambient temperature surrounding the liquid crystal display unit 2 and forms temperature compensation data from the detected temperature.

The blue and green scanning driver 45 is connected to the scanning electrodes 14a of the blue liquid crystal panel 10, and the blue data driver 42 is connected to the data electrodes 14b thereof. The blue and green scanning driver 45 is also connected to the scanning electrodes 24a of the green liquid crystal panel 20, and the green data driver 43 is connected to the data electrodes 24b thereof. In other words, the scanning signals for the blue liquid crystal panel 10 and green liquid crystal panel 20 are provided from a single blue and green scanning driver 45. While not shown in FIGS. 1 through 3 for the purpose of simplifying the drawings, the drivers 42, 43, 44, 45 and 46 each include five output terminals, which are respectively connected to their corresponding electrode. For example, the five output terminals of the data driver 42 (B-column) are respectively connected to five data electrodes 14b of the liquid crystal panel 10. The five output terminals of the blue and green scanning driver 45 (B/G-row) are respectively connected to the five scanning electrodes 14a of the liquid crystal panel 10, as well as to the five scanning electrodes 14a of the liquid crystal panel 20.

In the above preferred embodiment, the blue liquid crystal panel 10 comprises a single liquid crystal panel for example, but it may comprise two blue liquid crystal panels (not shown in the drawings) that are glued together, each having a liquid crystal helical structure oriented in a different direction (i.e., different helical sense). Further, the liquid crystal display unit 2 may comprise a total of six liquid crystal panels (not shown in the drawings), in which the liquid crystal panels 10, 20 and 30 each comprise two liquid crystal panels glued together, each having a liquid crystal helical structure in a different direction. In this case, if the blue liquid crystal panel and green liquid crystal panel (comprising a total of four panels) are driven using one scanning driver, and the red liquid crystal panel (comprising a total of two panels) is driven using one scanning driver based on the present invention, images that are easy to observe may be formed.

In the embodiment described above, one scanning driver is used for more than one liquid crystal layer based on the order of stacking of the liquid crystal layers 16, 26 and 36, but it is also acceptable if this determination is made based on the temperature characteristic of the liquid crystal layers 16, 26 and 36. For example, where the temperature characteristic of the blue liquid crystal layer 16 and that of the green liquid crystal layer 26 are essentially the same (for example, where the temperature coefficient—the voltage change based on temperature—is 1V/deg), and the temperature characteristic of the red liquid crystal layer 36 is different (where the temperature coefficient is 1.5V/deg, for example), the same scanning driver may be used for the blue liquid crystal layer 16 and green liquid crystal layer 26 that have essentially the same temperature characteristic, while a separate scanning driver is used for the red liquid crystal layer 36. Temperature compensation for the liquid crystal layers is carried out by changing the scanning drive voltage or the drive pulse width. If the same scanning driver is used for two liquid crystal layers based on the temperature characteristic, more accurate temperature compensation may be performed than when a single scanning driver is used for the liquid crystal layers 16, 26 and 36. In addition, in comparison with the case in which separate scanning drivers are used to drive the liquid crystal layers 16, 26 and 36, the number of scanning drivers may be reduced.

As explained above, using the embodiments described above, the blue liquid crystal display panel 10 and green liquid crystal display panel 20 may be driven using a single scanning driver and the red liquid crystal display panel 30 may be driven using a different scanning driver without compromising the overall ease of observation as a liquid crystal display device, and therefore, the number of scanning drivers, which has conventionally been three in order to drive the blue, green and red liquid crystal panels, may be reduced by one.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A liquid crystal display device comprising:
a first liquid crystal display unit comprising at least two liquid crystal layers;
a second liquid crystal display unit, stacked on the first liquid crystal display unit, comprising at least one liquid crystal layer;
a first drive circuit that is used for the at least two liquid crystal layers of the first liquid crystal display unit and drives the first liquid crystal display unit; and
a second drive circuit that drives the second liquid crystal display unit.

2. A liquid crystal display device as claimed in claim 1, wherein the first liquid crystal display unit is provided at an observation side of the second liquid crystal display unit.

3. A liquid crystal display device as claimed in claim 2, wherein the first liquid crystal display unit has a blue liquid crystal layer that selectively reflects blue light and a green liquid crystal layer that selectively reflects green light, and that the second liquid crystal display unit has a red liquid crystal layer that selectively reflects red light.

4. A liquid crystal display device as claimed in claim 1, wherein the first liquid crystal display unit has a blue liquid crystal layer that selectively reflects blue light and a green liquid crystal layer that selectively reflects green light, and that the second liquid crystal display unit has a red liquid crystal layer that selectively reflects red light.

5. A liquid crystal display device as claimed in claim 1, wherein each liquid crystal layer of the first and second liquid crystal display units includes a plurality of scanning electrodes and a plurality of signal electrodes.

6. A liquid crystal display device as claimed in claim 5, wherein each of the first and second drive circuits comprises a scanning electrode drive circuit that is connected to the scanning electrodes of each liquid crystal display unit.

7. A liquid crystal display device as claimed in claim 1, wherein the liquid crystal layers of the first liquid crystal display unit have substantially the same temperature characteristic.

8. A liquid crystal display device comprising:
a first liquid crystal panel comprising a first liquid crystal layer and a plurality of first scanning electrodes that are located so as to work with the first liquid crystal layer;
a second liquid crystal panel comprising a second liquid crystal layer and a plurality of second scanning electrodes that are located so as to work with the second liquid crystal layer;
a third liquid crystal panel comprising a third liquid crystal layer and a plurality of third scanning electrodes that are located so as to work with the third liquid crystal layer;
a first scanning electrode drive circuit, provided common to the first and second liquid crystal layers, connected to the first scanning electrodes and the second scanning electrodes; and
a second scanning electrode drive circuit connected to the third scanning electrodes.

9. A liquid crystal display device as claimed in claim 8, further comprising:
a plurality of first signal electrodes that are located such that they work with the first liquid crystal layer;
a plurality of second signal electrodes that are located such that they work with the second liquid crystal layer;
a plurality of third signal electrodes that are located such that they work with the third liquid crystal layer;
a first signal electrode drive circuit that is connected to the first signal electrodes;
a second signal electrode drive circuit that is connected to the second signal electrodes; and
a third signal electrode drive circuit that is connected to the third signal electrodes.

10. A liquid crystal display device as claimed in claim 8, wherein the first, second and third liquid crystal layers are for selectively reflecting blue light, green light and red light, respectively.

11. A liquid crystal display device as claimed in claim 8, wherein a temperature characteristic of the first liquid crystal layer and that of the second liquid crystal layer are substantially identical.
